(19) United States
(12) Patent Application Publication
(10) Pub. No.: US 2023/0399269 A1
(43) Pub. Date: Dec. 14, 2023

(54) Method for Preparing N-P Compound Fertilizer from Incinerated Sewage Sludge Ash (ISSA)

(71) Applicant: Sichuan University, Sichuan (CN)

(72) Inventors: Min LIU, Sichuan (CN); Ying CHEN, Sichuan (CN); He HONG, Sichuan (CN)

(21) Appl. No.: 18/206,595

(22) Filed: Jun. 6, 2023

(30) Foreign Application Priority Data
Jun. 8, 2022 (CN) 202210644804.X

(51) Int. Cl. C05F 7/00

(52) U.S. Cl. CPC C05F 7/005

(57) ABSTRACT

The present disclosure provides a method for preparing an N-P compound fertilizer from incinerated sewage sludge ash (ISSA), and relates to the technical field of compound fertilizer production. In the present disclosure, the ISSA is used as a main raw material, and a phosphorus-rich supernatant is obtained using high-concentration nitric acid at a low liquid-to-solid ratio. The phosphorus-rich supernatant and aqueous ammonia are mixed to obtain a white precipitate. The white precipitate is dried and pulverized to obtain a high-grade N-P compound fertilizer. The present disclosure realizes the resource utilization of excess sludge in sewage treatment plants.

### CROSS REFERENCE TO RELATED APPLICATION

This patent application claims the benefit and priority of Chinese Patent Application No. 202210644804.X, filed with the China National Intellectual Property Administration on Jun. 8, 2022, the disclosure of which is incorporated by reference herein in its entirety as part of the present application.

### TECHNICAL FIELD

The present disclosure relates to the technical field of compound fertilizer production, in particular to a method for preparing an N-P compound fertilizer from incinerated sewage sludge ash (ISSA) of a municipal sewage treatment plant.

### BACKGROUND

Currently, phosphorus extraction from incinerated sewage sludge ash (ISSA) mainly relies on thermochemical, electrodialysis, ion exchange, adsorption, biological, and wet chemical methods. The thermochemical, electrodialysis, ion exchange, adsorption, and biological methods all have bottlenecks in the industrial application, while the wet chemical method has corresponding industrial applications at present, and shows operability and a sound theoretical basis. However, current researches on the wet chemical method have the following problems. (1) The research of wet chemical method mainly focuses on the extraction of sulfuric acid and hydrochloric acid, and does not meet the national conditions of sulfur deficiency, thereby leading to high fertilizer prices, affecting the purchasing power of farmers, and lacking practical application considerations. (2) Sulfuric acid easily reacts with Ca in the ISSA to form gypsum (CaSO₄), which is attached to a surface of the ISSA, hindering a further reaction and resulting in a decrease in phosphorus extraction rate. (3) HCl has a relatively high amount of metal leaching during the extraction, which is not conducive to the enrichment and purification of phosphorus. (4) The wet chemical method needs to conduct extraction at a high liquid-to-solid ratio, which not only produces more waste liquid, but also is not conducive to the subsequent enrichment and purification of phosphorus, thus lacking the consideration of operating costs. (5) After the phosphorus in ISSA is extracted by the wet chemical method, there is a lack of follow-up exploration of related phosphorus reuse, which is not conducive to the formation of complete process flow and theoretical system. One of the reasons for the above problems is that the current phosphorus recycling process for phosphorus-rich extracts is not well developed. Both the struvite crystallization method and vivianite recovery method have strict requirements on operating conditions, and show a poor recovery rate of phosphorus. In particular, these methods are useless for sewage treatment plants that generally adopt aluminum salts as a flocculant. In addition, the calcium phosphate crystallization method is greatly disturbed by coexisting ions, and then difficult to form pure crystals with large particle sizes, resulting in a limited recovery rate of phosphorus.

In addition, patents in the prior art on use of phosphorus in sludge to prepare phosphate fertilizers mainly include: preparation of fertilizers by phosphorus leaching from fresh sludge, and preparation of phosphate fertilizers using phosphorus in the ISSA obtained after sludge drying and incineration. The above methods generally have complex operation procedures and difficult control of operation conditions. Moreover, a lot of chemicals are added in these methods, and cause a large amount of waste liquid generated, leading to great energy consumption and high cost and the like. In addition, due to the complex and diverse components contained in the sludge, there is a risk of leaching harmful elements such as heavy metals during the preparation of phosphate fertilizers. As a result, relatively harsh operating conditions, such as calcination and ion exchange, are generally adopted, thus greatly increasing a production cost of the product.

### SUMMARY

In order to solve the above problems and respond to the increasing demand for compound fertilizers in the current agricultural market, the present disclosure provides a method for preparing an N-P compound fertilizer by ISSA. The method has a simple operation process, a low cost, and a high recovery rate, and includes the following steps:
(1) weighing the ISSA, drying to a constant weight, and cooling in an airtight environment;
(2) heating and mixing a nitric acid solution with the ISSA to obtain a mixed solution;

Ca₉(Al)(PO₄)₇+21H⁺→9Ca₂⁺+Al₃⁺+7H₃PO₄
(3) subjecting the mixed solution to a reaction by fully stirring in a constant-temperature stirring device, and conducting centrifugation on an obtained reacted mixed solution to avoid formation of colloids, thereby obtaining a phosphorus-rich supernatant and an ISSA residue;
(4) adjusting the phosphorus-rich supernatant to a pH value of 6 to 8 using aqueous ammonia with a mass fraction of 15% to 25%, conducting a reaction fully under stirring to obtain a white turbid liquid, and conducting centrifugation on the white turbid liquid to avoid formation of colloids, thereby obtaining a white precipitate; and

Ca(NO₃)₂+H₃PO₄+2NH₃·H₂O→CaHPO₄·2H₂O↓+2NH₄NO₃

Al(NO₃)₃+H₃PO₄+3NH₃·H₂O→AlPO₄↓+3NH₄NO₃+3H₂O
in the present disclosure, by adjusting the pH value using aqueous ammonia with a specific mass fraction, phosphorus can be transferred into the precipitate, so as to improve a recovery rate of phosphorus in the precipitate; if the aqueous ammonia has an insufficient concentration, most of the phosphorus remains in the supernatant, leading to a decreased yield;
(5) subjecting the white precipitate to drying, pulverizing, and sieving by a 100-mesh sieve to obtain the N-P compound fertilizer.

Further, in step (1), the drying is conducted at 90° C. to 110° C.

Further, in step (2), the nitric acid solution has a concentration of 3.0 mol/L to 7.0 mol/L and a temperature of 20° C. to 45° C.

Further, in step (2), the nitric acid solution and the ISSA are at a liquid-to-solid ratio of (2.5-5.0) mL:1 g.

Further, in step (3), the stirring is conducted at 20° C. to 45° C. and 200 rpm to 400 rpm for 10 min to 30 min.

Further, in step (3), the centrifugation is conducted at 5,000 rpm to 6,500 rpm for 5 min to 10 min.

Further, in step (4), the reaction is conducted at 25° C. to 55° C. and 300 rpm to 600 rpm for 25 min to 60 min.

Further, in step (4), the centrifugation is conducted at 5,000 rpm to 6,500 rpm for 5 min to 10 min.

Further, in step (4), the drying is conducted at 90° C. to 110° C. for 6 h to 10 h.

The present disclosure further provides an N-P compound fertilizer prepared by the method.

Compared with the prior art, the present disclosure has the following beneficial technical effects.
(1) In the present disclosure, the method adopts the ISSA from sewage treatment plants as a raw material, which can be used as a beneficial supplement for phosphorus production from phosphate rocks, thereby reducing the mining of phosphate rocks and the ensuing environmental problems. Meanwhile, the method provides an effective method for the disposal of excess sludge, realizes resource utilization of excess sludge in the sewage treatment plants, and serves multiple purposes.
(2) In the present disclosure, a complete set of technical flow process system for preparing an N-P compound fertilizer using the ISSA has been developed. The system effectively solves the reutilization of the ISSA, obtains the N-P compound fertilizer with market prospects, and can be applied in the field of agriculture.
(3) In the present disclosure, the method overcomes the deficiency of extraction with sulfuric acid or hydrochloric acid in the existing wet chemical method. The extraction of phosphorus in the ISSA using nitric acid as an extractant is suitable for the national conditions of overcapacity and oversupply of nitric acid. The extraction with nitric acid reduces production costs and digests part of the nitric acid to stimulate demand.
(4) In the present disclosure, high-concentration nitric acid is used to extract phosphorus at a low liquid-to-solid ratio. This not only enables the effective leaching of phosphorus, but also the leaching of other elements. The whole solution system contains various elements, such as Ca²⁺, K⁺, Mg²⁺, Al₃⁺, Fe²⁺, and Fe³⁺.
(5) In the present disclosure, the pH value in a phosphorus-rich extract is adjusted by adding aqueous ammonia to produce an N-P compound fertilizer precipitation. Most of the metals are precipitated into the N-P compound fertilizer in a form of phosphate, accompanied by a large amount of ammonium nitrate produced. Therefore, the N-P compound fertilizer not only contains a large amount of nitrogen and phosphorus, but also contains various trace elements (such as Ca²⁺, K⁺, Mg²⁺, Al₃⁺, Fe²⁺, and Fe³⁺), and can provide multiple nutrients for plants.
(6) In the present disclosure, the method has simple operation procedures and conditions, generates less waste, and effectively controls operating costs. Accordingly, this method can be applied in the current nitrophosphate fertilizer production workshop, and has the conditions for practical application.

### BRIEF DESCRIPTION OF THE DRAWINGS

The present disclosure will be further described below with reference to the accompanying drawings.

FIG. 1 shows a process flow diagram of the method for preparing an N-P compound fertilizer by ISSA in the present disclosure.

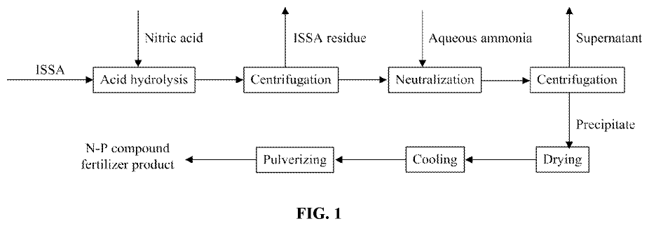

### DETAILED DESCRIPTION OF THE EMBODIMENTS

The present disclosure provides a method for preparing an N-P compound fertilizer by ISSA. The method has a simple operation process, a low cost, and a high recovery rate, and includes the following steps:
(1) weighing the ISSA, drying to a constant weight, and cooling in an airtight environment;
(2) heating and mixing a nitric acid solution with the ISSA to obtain a mixed solution;
(3) subjecting the mixed solution to a reaction by fully stirring in a constant-temperature stirring device, and conducting centrifugation on an obtained reacted mixed solution to avoid formation of colloids, thereby obtaining a phosphorus-rich supernatant and an ISSA residue;
(4) adjusting the phosphorus-rich supernatant to a pH value of 6 to 8 using aqueous ammonia with a mass fraction of 15% to 25%, conducting a reaction fully under stirring to obtain a white turbid liquid, and conducting centrifugation on the white turbid liquid to avoid formation of colloids, thereby obtaining a white precipitate; and
(5) subjecting the white precipitate to drying, pulverizing, and sieving by a 100-mesh sieve to obtain the N-P compound fertilizer.

In one example, in step (1), the drying is conducted at 90° C. to 110° C.

In one example, in step (2), the nitric acid solution has a concentration of 3.0 mol/L to 7.0 mol/L and a temperature of 20° C. to 45° C.

In one example, in step (2), the nitric acid solution and the ISSA are at a liquid-to-solid ratio of (2.5-5.0) mL:1 g.

In one example, in step (3), the stirring is conducted at 20° C. to 45° C. and 200 rpm to 400 rpm for 10 min to 30 min.

In one example, in step (3), the centrifugation is conducted at 5,000 rpm to 6,500 rpm for 5 min to 10 min.

In one example, in step (4), the reaction is conducted at 25° C. to 55° C. and 300 rpm to 600 rpm for 25 min to 60 min.

In one example, in step (4), the centrifugation is conducted at 5,000 rpm to 6,500 rpm for 5 min to 10 min.

In one example, in step (4), the drying is conducted at 90° C. to 110° C. for 6 h to 10 h.

An N-P compound fertilizer is prepared by the method according to any one of claims 1 to 9.

The technical solutions provided by the present disclosure will be further described below with reference to the accompanying examples.

### Example 1

A method for preparing an N-P compound fertilizer by ISSA included the following steps:
(1) ISSA in an urban domestic sewage treatment plant was dried to a constant weight at 105° C.;
(2) a nitric acid solution with a concentration of 5 mol/L was heated to 25° C., and mixed with the ISSA at a liquid-to-solid ratio of 3 mL:1 g to obtain a mixed solution;
(3) the mixed solution was reacted by stirring in a constant-temperature stirring device at 25° C. and 300 rpm for 20 min, a resulting reacted mixed solution was centrifuged in a high-speed centrifugal device at 6,500 rpm for 5 min, and an obtained centrifuged product was subjected to solid-liquid separation to obtain a phosphorus-rich supernatant and an ISSA residue;
(4) the phosphorus-rich supernatant was poured into a reaction vessel, added dropwise with aqueous ammonia at a mass fraction of 25% to adjust a pH value to 7, and fully stirred in the constant-temperature stirring device at 50° C. and 400 rpm for 30 min to obtain a white suspension; the white suspension was centrifuged in the high-speed centrifugal device at 6,500 rpm for 5 min to obtain a white precipitate and an ammonia-neutralized supernatant; and
(5) the white precipitate was dried in a drying device at 90° C. for about 10 h to obtain a white lump, and the white lump was fully cooled in a sealed cooling device; an obtained cooled white lump was pulverized in a pulverizer for 5 min, and sieved by a 100-mesh sieve to obtain the N-P compound fertilizer containing a large amount of phosphorus.

After testing, the N-P compound fertilizer had N, P₂O₅, and K₂O of 28.00%, 13.70%, and 0.54%, respectively, and had a total nutrient content of 42.24%, thus reaching the level of excellent products (≥42.0%) among nitrophosphate fertilizers and nitric phosphate-potassium fertilizers.

### Example 2

A method for preparing an N-P compound fertilizer by ISSA included the following steps:
(1) ISSA in an urban domestic sewage treatment plant was dried to a constant weight at 105° C.;
(2) a nitric acid solution with a concentration of 3 mol/L was heated to 45° C., and mixed with the ISSA at a liquid-to-solid ratio of 5 mL:1 g to obtain a mixed solution;
(3) the mixed solution was reacted by stirring in a constant-temperature stirring device at 45° C. and 400 rpm for 15 min, a resulting reacted mixed solution was centrifuged in a high-speed centrifugal device at 6,000 rpm for 8 min, and an obtained centrifuged product was subjected to solid-liquid separation to obtain a phosphorus-rich supernatant and an ISSA residue;
(4) the phosphorus-rich supernatant was poured into a reaction vessel, added dropwise with aqueous ammonia at a mass fraction of 20% to adjust a pH value to 6, and fully stirred in the constant-temperature stirring device at 25° C. and 600 rpm for 40 min to obtain a white suspension; the white suspension was centrifuged in the high-speed centrifugal device at 6,000 rpm for 8 min to obtain a white precipitate and an ammonia-neutralized supernatant; and
(5) the white precipitate was dried in a drying device at 105° C. for about 8 h to obtain a white lump, and the white lump was fully cooled in a sealed cooling device; an obtained cooled white lump was pulverized in a pulverizer for 3 min, and sieved by a 100-mesh sieve to obtain the N-P compound fertilizer containing a large amount of phosphorus.

After testing, the N-P compound fertilizer had N, P₂O₅, and K₂O of 25.54%, 11.24%, and 4.57%, respectively, and had a total nutrient content of 41.35%, thus reaching the level of first-class products (≥40.0%) among nitrophosphate fertilizers and nitric phosphate-potassium fertilizers.

### Comparative Example 1

A method for preparing a compound fertilizer by phosphorus in ISSA included the following steps:
(1) ISSA in an urban domestic sewage treatment plant was dried to a constant weight;
(2) a nitric acid solution with a concentration of 1 mol/L was heated to 35° C., and mixed with the ISSA at a liquid-to-solid ratio of 2 mL:1 g to obtain a mixed solution;
(3) the mixed solution was reacted by stirring in a constant-temperature stirring device at 35° C. and 200 rpm for 50 min, a resulting reacted mixed solution was centrifuged in a high-speed centrifugal device at 6,500 rpm for 5 min, and an obtained centrifuged product was subjected to solid-liquid separation to obtain a phosphorus-rich supernatant and an ISSA residue;
(4) the phosphorus-rich supernatant was poured into a reaction vessel, added dropwise with aqueous ammonia at a mass fraction of 10% to adjust a pH value to 3, and fully stirred in the constant-temperature stirring device at 25° C. and 200 rpm for 10 min to obtain a white suspension; the white suspension was centrifuged in the high-speed centrifugal device at 6,500 rpm for 5 min to obtain a white precipitate and an ammonia-neutralized supernatant; and
(5) the white precipitate was dried in a drying device at 105° C. for about 6 h to obtain a white lump, and the white lump was fully cooled; an obtained cooled white lump was pulverized in a pulverizer for 3 min, and sieved by a 100-mesh sieve to obtain the N-P compound fertilizer containing a large amount of phosphorus. After testing, the N-P compound fertilizer had N, P₂O₅, and K₂O of 19.82%, 7.67%, and 2.35%, respectively, and had a total nutrient content of 29.84%, thus reaching the level of unqualified products (38.0%) among nitrophosphate fertilizers and nitric phosphate-potassium fertilizers.

It was seen that when using nitric acid to extract phosphorus in ISSA at a low liquid-to-solid ratio, the phosphorus extraction was insufficient to cause low phosphorus content in the extract. Therefore, the subsequently prepared compound fertilizer had a low content of nutrient elements and could not meet the requirements of relevant standards.

### Comparative Example 2

A method for preparing a compound fertilizer by phosphorus in ISSA included the following steps:
(1) ISSA in an urban domestic sewage treatment plant was dried to a constant weight;
(2) a nitric acid solution with a concentration of 5 mol/L was heated to 25° C., and mixed with the ISSA at a liquid-to-solid ratio of 3 mL:1 g to obtain a mixed solution;
(3) the mixed solution was reacted by stirring in a constant-temperature stirring device at 25° C. and 300 rpm for 20 min, a resulting reacted mixed solution was centrifuged in a high-speed centrifugal device at 6,500 rpm for 5 min, and an obtained centrifuged product was subjected to solid-liquid separation to obtain a phosphorus-rich supernatant and an ISSA residue;
(4) the phosphorus-rich supernatant was poured into a reaction vessel, added dropwise with aqueous ammonia at a mass fraction of 15% to adjust a pH value to 4, and fully reaction in the constant-temperature stirring device at 70° C. and 0 rpm (namely without stirring) for 20 min to obtain a white suspension; the white suspension was centrifuged in the high-speed centrifugal device at 6,500 rpm for 5 min to obtain a white precipitate and an ammonia-neutralized supernatant; and
(5) the white precipitate was dried in a drying device at 105° C. for about 10 h to obtain a white lump, and the white lump was fully cooled; an obtained cooled white lump was pulverized in a pulverizer for 5 min, and sieved by a 100-mesh sieve to obtain the N-P compound fertilizer containing a large amount of phosphorus. After testing, the N-P compound fertilizer had N, P₂O₅, and K₂O of 20.59%, 9.88%, and 2.74%, respectively, and had a total nutrient content of 33.21%, thus reaching the level of unqualified products (38.0%) among nitrophosphate fertilizers and nitric phosphate-potassium fertilizers.

It was seen that the phosphorous in the ISSA was extracted by nitric acid, and the obtained phosphorous-containing extract had a higher phosphorous content. However, during the ammonia neutralization by aqueous ammonia, improper operating conditions led to low phosphorus content in the white precipitate. Therefore, the compound fertilizer obtained by drying and pulverizing had low nutrient element contents and could not meet the requirements of relevant standards. Only under the cooperation of the method designed in the present disclosure, the raw materials, and the technical parameters of each process, could phosphorus be successfully extracted from the ISSA and prepared to obtain the N-P compound fertilizer.

### Test Example 1

The N-P compound fertilizers obtained in Examples 1 to 2 presented a white powder; by observation under an optical microscope, the compound fertilizer was in an amorphous state. Observation under a scanning electron microscope (SEM) showed that the surface and interior of the N-P compound fertilizer were in an amorphous state, and various structures were mixed together to form a compound. Moreover, there were generally clusters of protrusions similar to unit cells on the surface, making the surface of the N-P compound fertilizer not smooth. Occasionally, rod-like structures appeared in these fragmented compounds. It was seen that some substances with better crystallization were also formed in the amorphous state. The N-P compound fertilizer was basically an inorganic compound composed of many amorphous substances.

### Test Example 2 Pot Plant Verification Experiment

The pot plant experiment of ryegrass was conducted with the N-P compound fertilizer obtained in Example 1. The growth as well as fresh weight (dry weight), root length, plant height, leaf length, and chlorophyll content of the ryegrass were all desirable, and compared with a non-fertilization group, there was a significant promotion effect. Moreover, no heavy metal elements (Cu, Cd, Pb, Cr, As, and Hg) were detected from the plants, so it was seen that fertilization did not cause the accumulation of heavy metals in plants. Simultaneously, soil pH, organic matter, total nitrogen, and total phosphorus did not deteriorate, and the heavy metals (Cu, Cd, Pb, Cr, As, and Hg) were not detected, indicating that fertilization had little impact on the soil.

Specific examples are used herein to explain the principles and implementations of the present disclosure. The foregoing description of the embodiments is merely intended to help understand the method of the present disclosure and its core ideas; besides, various modifications may be made by a person of ordinary skill in the art to specific embodiments and the scope of application in accordance with the ideas of the present disclosure. In conclusion, the content of the present specification shall not be construed as limitations to the present disclosure.

What is claimed is:

1. A method for preparing an N-P compound fertilizer from incinerated sewage sludge ash (ISSA), comprising the following steps:
(1) weighing the ISSA, drying to a constant weight, and cooling in an airtight environment;
(2) heating and mixing a nitric acid solution with the ISSA to obtain a mixed solution;
(3) subjecting the mixed solution to a reaction by fully stirring in a constant-temperature stirring device, and conducting centrifugation on an obtained reacted mixed solution to avoid formation of colloids, thereby obtaining a phosphorus-rich supernatant and an ISSA residue;
(4) adjusting the phosphorus-rich supernatant to a pH value of 6 to 8 using aqueous ammonia with a mass fraction of 15% to 25%, conducting a reaction fully under stirring to obtain a white turbid liquid, and conducting centrifugation on the white turbid liquid to avoid formation of colloids, thereby obtaining a white precipitate; and
(5) subjecting the white precipitate to drying, pulverizing, and sieving by a 100-mesh sieve to obtain the N-P compound fertilizer.

2. The method for preparing an N-P compound fertilizer by ISSA according to claim 1, wherein in step (1), the drying is conducted at 90° C. to 110° C.

3. The method for preparing an N-P compound fertilizer by ISSA according to claim 1, wherein in step (2), the nitric acid solution has a concentration of 3.0 mol/L to 7.0 mol/L and a temperature of 20° C. to 45° C.

4. The method for preparing an N-P compound fertilizer by ISSA according to claim 1, wherein in step (2), the nitric acid solution and the ISSA are at a liquid-to-solid ratio of (2.5-5.0) mL:1 g.

5. The method for preparing an N-P compound fertilizer by ISSA according to claim 1, wherein in step (3), the stirring is conducted at 20° C. to 45° C. and 200 rpm to 400 rpm for 10 min to 30 min.

6. The method for preparing an N-P compound fertilizer by ISSA according to claim 1, wherein in step (3), the centrifugation is conducted at 5,000 rpm to 6,500 rpm for 5 min to 10 min.

7. The method for preparing an N-P compound fertilizer by ISSA according to claim 1, wherein in step (4), the reaction is conducted at 25° C. to 55° C. and 300 rpm to 600 rpm for 25 min to 60 min.

8. The method for preparing an N-P compound fertilizer by ISSA according to claim 1, wherein in step (4), the centrifugation is conducted at 5,000 rpm to 6,500 rpm for 5 min to 10 min.

9. The method for preparing an N-P compound fertilizer by ISSA according to claim 1, wherein in step (4), the drying is conducted at 90° C. to 110° C. for 6 h to 10 h.

10. An N-P compound fertilizer prepared by the method according to claim 1.

11. The N-P compound fertilizer according to claim 10, wherein in step (1), the drying is conducted at 90° C. to 110° C.

12. The N-P compound fertilizer according to claim 10, wherein in step (2), the nitric acid solution has a concentration of 3.0 mol/L to 7.0 mol/L and a temperature of 20° C. to 45° C.

13. The N-P compound fertilizer according to claim 10, wherein in step (2), the nitric acid solution and the ISSA are at a liquid-to-solid ratio of (2.5-5.0) mL:1 g.

14. The N-P compound fertilizer according to claim 10, wherein in step (3), the stirring is conducted at 20° C. to 45° C. and 200 rpm to 400 rpm for 10 min to 30 min.

15. The N-P compound fertilizer according to claim 10, wherein in step (3), the centrifugation is conducted at 5,000 rpm to 6,500 rpm for 5 min to 10 min.

16. The N-P compound fertilizer according to claim 10, wherein in step (4), the reaction is conducted at 25° C. to 55° C. and 300 rpm to 600 rpm for 25 min to 60 min.

17. The N-P compound fertilizer according to claim 10, wherein in step (4), the centrifugation is conducted at 5,000 rpm to 6,500 rpm for 5 min to 10 min.

18. The N-P compound fertilizer according to claim 10, wherein in step (4), the drying is conducted at 90° C. to 110° C. for 6 h to 10 h.
